(19) United States
(12) Patent Application Publication
(10) Pub. No.: US 2010/0263301 A1
(43) Pub. Date: Oct. 21, 2010

(54) ENERGY-SAVING BAFFLE

(75) Inventor: Victor MARTIN, Pasadena, MD (US)

Correspondence Address: PRASS LLP, 2661 Riva Road, Bldg. 1000, Suite 1044, ANNAPOLIS, MD, 21401, US

(73) Assignees: Mr. Ronald E. Prass, JR., Davidsonville, MD (US); Mr. Victor Martin, Pasadena, MD (US)

(21) Appl. No.: 12/830,207

(22) Filed: Jul. 2, 2010

Related U.S. Application Data
(63) Continuation-in-part of application No. 11/530,570, filed on Sep. 11, 2006, now abandoned.

(51) Int. Cl. E04D 13/17; E04B 7/00; E04C 2/20; E04B 1/70; B23P 11/00; B21D 47/00

(52) U.S. Cl. 52/95; 52/198; 52/173.1; 52/588.1; 52/309.1; 52/302.1; 29/428; 29/897.3

(57) ABSTRACT

The invention concerns an energy-saving baffle. In this regard, the invention may include a baffle of synthetic material that may have insulating properties and a shape and a size to be positioned beneath the roof and attached to framing members that connect a top plate of a wall with an apex of a roof. The baffle may be positioned in proximity of the top plate, wherein the insulating properties and positioning of the synthetic block provide an increase of insulation R-value at or above a predetermined threshold in the area beneath the roof.

### PRIORITY INFORMATION

This application claims priority as a continuation-in-part of U.S. patent application Ser. No. 11/530,570, filed, Sep. 11, 2006, the content of which is incorporated herein by reference in its entirety.

### BACKGROUND OF THE INVENTION

1. Field of the Invention

The present invention relates to an insulating product for residential and certain commercial construction applications.

2. Introduction

Standard construction practice over the past several years has been to use engineered-designed roof trusses with a standard heel height giving the end result of about five to six inches of height overall above the double top plate of the outside wall of the house. This arrangement leaves little room for proper insulation. In fact, the maximum R-value (which indicates the resistance a material or space has to heat flow) that can be achieved is 19, which is well-below the level mandated by virtually all local building codes.

Until recently, inspectors have overlooked this issue and have not been requiring builders and remodelers to raise the heel height to accommodate the proper installation of insulation thick enough to meet the R-values required by Building Codes throughout the United States. Therefore, to meet today's (and past) energy codes, this required R-value may only be achieved by raising the heel height of the roof trusses several inches (even a foot in some cases) the home an additional inch so that an air baffle for ventilation may be installed. Raising this heel height for each roof truss is a very expensive process. Furthermore, this process also requires the additional sheathing and installation of siding or brick which adds more to the overall costs of construction and labor.

There have been other issues concerning this problem such as ice damming which is caused by not enough or improperly install insulation and mold issues due to lack of air ventilation which causes failure to roof sheathing and premature failure to the life of the installed roof shingles.

The conventional standard for air baffles has been to use cardboard air baffles that are installed by stapling the cardboard into the roof trusses or rafters. Due to the flimsy nature of the baffles, they become detached upon the installation of blown insulation and eventually fall down over time which requires the homeowner or contractor to climb thru attics to reinstall or replace these baffles. When these baffles fall and are not repaired, insulation falls into the vented soffits and restricts the flow air needed for ventilation. Moreover, if the cardboard baffle is not long enough, the blown insulation will also fall into the vented soffit.

Others have tried to use a thin piece of Styrofoam as a baffle in place of the cardboard and chink it with insulation between the top plate of the outside wall and the bottom of the roof sheathing. However, since the Styrofoam baffle is required to be stapled directly to the underside of the roof sheathing, it has the tendency to fall and break in half.

### SUMMARY OF THE INVENTION

The invention concerns an energy-saving baffle. The invention may include a baffle of synthetic material that may have insulating properties and a shape and a size to be positioned beneath the roof and attached to framing members that connect a top plate of a wall with an apex of a roof. The baffle may be positioned in proximity of the top plate, wherein the insulating properties and positioning of the synthetic block provide an increase of insulation R-value at or above a predetermined threshold in the area beneath the roof.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIGS. 1A-1C illustrate exemplary diagrams of an energy-saving baffle and FIG. 1D illustrates an exemplary attachment device in accordance with a possible embodiment of the invention;

FIGS. 2A-2C illustrate exemplary diagrams of an energy-saving baffle accordance with another possible embodiment of the invention;

FIGS. 3A-3C illustrate the exemplary positioning of the energy-saving baffle in accordance with a possible embodiment of the invention; and

FIGS. 4A-4C illustrate the exemplary positioning of the energy-saving baffle in accordance with a possible embodiment of the invention;

FIGS. 5A-5C illustrate exemplary diagrams of another energy-saving baffle in accordance with a possible embodiment of the invention;

FIGS. 6A-6C illustrate the exemplary positioning of the energy-saving baffle in accordance with a possible embodiment of the invention; and

FIGS. 7A-7C illustrate the exemplary positioning of the energy-saving baffle in accordance with a possible embodiment of the invention.

### DETAILED DESCRIPTION OF THE INVENTION

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

The present invention comprises a variety of embodiments, such as an apparatus and method, and other embodiments that relate to the basic concepts of the invention.

The resistance a material has to heat flow. Higher numbers indicate greater insulating capabilities. A unit of thermal resistance used for comparing insulating values of different materials. The higher the R-Value of a material, the greater its insulating properties and the slower the heat flows through it. For example, typical new home's walls are usually insulated with 3.5″ batt insulation with an R value of R-13, and a ceiling insulation of R-38. The greater the “R” value gives you a greater resistance to heat flow. The higher the “R” value will save money and reduce the amount of energy used.

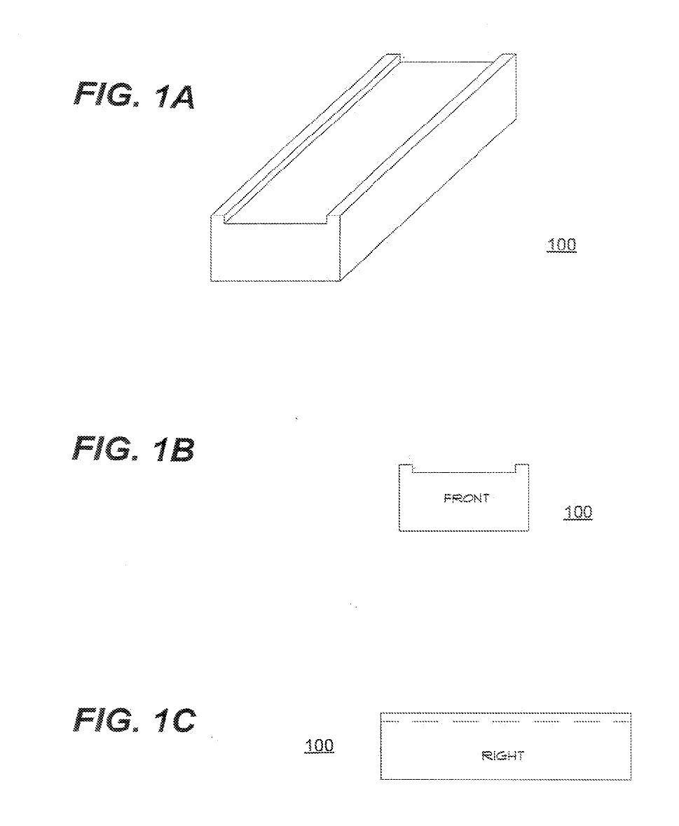

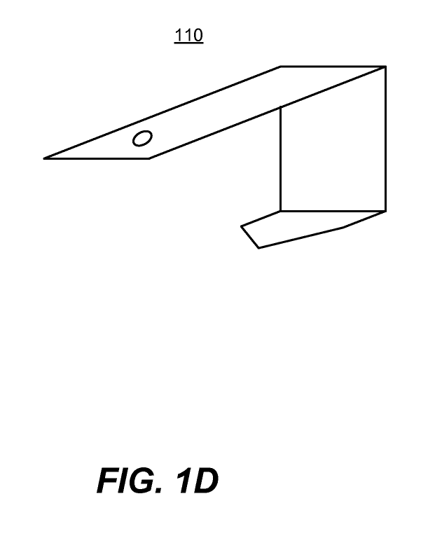

Building codes have been adopted throughout the United States and vary from one state to the next with different jurisdictions amending the building codes for their area. For years building officials have looked the other way and have not been concerned with the issue of achieving the required “R” value at the attic eave area. The consumer is entered into a contract with the builder or home improvement contractor and the contractor is required to state the “R” values throughout the residence. It is misleading to the consumer when they are given information that is not true. FIG. 1A illustrates an exemplary energy-saving baffle 100 in accordance with a possible embodiment of the invention. FIG. 1B shows a front view and FIG. 1C shows a side view of the exemplary energy-saving baffle 100. The energy-saving baffle 100 may be constructed of polyurethane foam, polystyrene foam or any similar material, for example, specifically manufactured to provide the desired insulating values. However, one of skill in the art can appreciate that any insulating material may be used in accordance with the invention as long as the material provides the required insulating properties.

The energy-saving baffle 100 of the invention concerns increase industry standard insulation values, known as R-values, to meet regulatory and building codes in residential and certain commercial structures. An R-value is a measurement of the resistance a material or combination of materials has to heat flow. As such, an R-value provides a unit of thermal resistance used for comparing insulating values of different materials. The higher the R-value is in number the greater the insulating capabilities the material or combination of materials has. In other words, the higher the R-Value of a material, the greater its insulating properties and the slower the heat flows through it. The higher the “R” value will save money and reduce the amount of energy used. As a means of illustration, a typical new home's walls are may be insulated with 3.5-inches of fiberglass batt insulation with an R value of R-13, and a ceiling with fiberglass blown insulation to a value of R-38.

Building codes have been adopted throughout the United States and vary from one state, county or other geographic area to the next. Until recently, building officials have not been concerned with the issue of achieving the required “R” value at the attic eave area. The previous methods of achieving the required R-value are either inadequate or cost-prohibitive. However, the energy-saving baffle 100 shown in FIGS. 1A-1C meets current Energy Building Codes with minimum changes to construction practices in use today.

With respect to possible embodiments for example, the energy-saving baffle 100, 200 may be manufactured to fit between engineered roof trusses 24 inches on center or may be manufactured to fit between conventional framed rafters 16 inches on center. Materials and installation may be the same for both applications.

With FIG. 1A-1C shows the baffle 100 to be of rectangular shape, the baffle may be in the shape of a half-cylinder, half-sphere, rectangle, square, half-square, or any other polygon or three-dimensional shape as long as the required insulating properties are achieved.

The size of the baffle 100 may also vary. For example, the length of the baffle 100 can vary such that it may be pre-cut to provide a certain R-value, or it may be sold at a standard length. In this regard, the baffle 100 may be sold in eight, ten, or twelve foot lengths and may be cut to a desired length out in the field. A contractor can compute a proper length for the baffle 100 to meet and exceed the R-value threshold based on a table or through the use of a computer program.

The baffle 100 is shown in FIGS. 1A-1C to have ridges on the edges to facilitate fitting between a framing member (rafter, roofing beam, etc.). However, the face baffle 100 facing the roofing beam can be smooth, have several ridges, etc. as long as the required insulating properties can be achieved.

The baffle 100 may attached directly to the roofing beam but may also include an attachment device 110 as shown in FIG. 1D connected to the baffle 100 to facilitate positioning the baffle atop the roofing beams. The attachment device 110 may be any type of attachment device known to those of skill in the art to allow the baffle 100 to fit atop roofing beam. For example, the attachment device 110 for the baffle 100 may be a flange or pair of flanges made of plastic or metal. The flanges may be attached to any structure as long as the desired insulating properties are achieved, including the roof, the roof sheathing, a framing member, a roofing beam or a rafter using any type of fastening devices. The fastening devices may be any type known to those of skill in the art including nails, tacks, staples, screws, rivets, glue, Velcro, tape, or clips. In addition, the flange may be designed to fit or slide inside of a rail or clip system designed to hold the flanges.

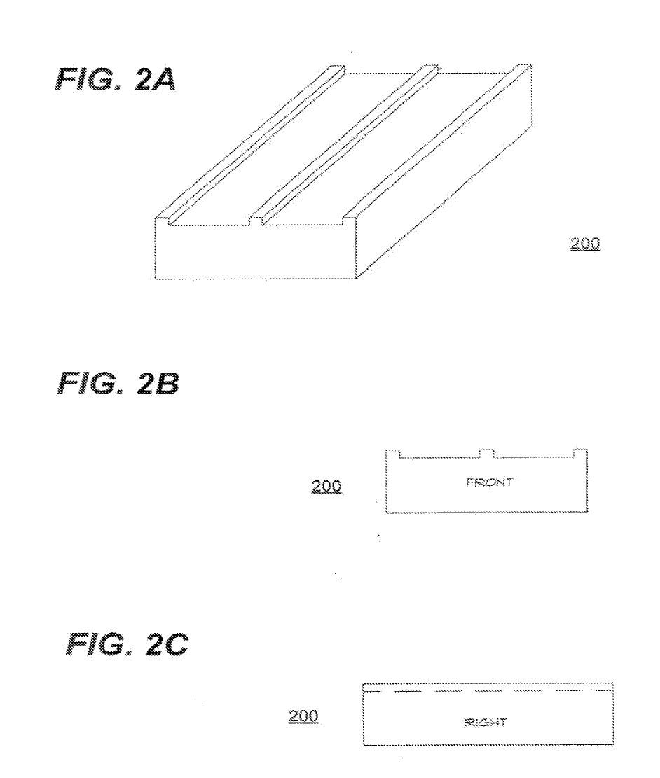

FIG. 2A illustrates another exemplary energy-saving baffle 200 in accordance with a possible embodiment of the invention. FIG. 2B shows a front view and FIG. 2C shows a side view of the exemplary energy-saving baffle 200. This baffle 200 has the same properties as discussed above, however it is in a size and shape to cover more than one roofing beam. The raised ridge in the center of the baffle 200 may be placed between the beams in certain engineered roof trusses, thus providing the baffle 200 additional support and consistency in the middle since the baffle 200 is larger than the embodiment in FIGS. 1A-1C. However, the baffle 200 may be configured to be smooth or have multiple ridges across the face of the baffle 200 facing the beam. As in FIGS. 1A-1C, the baffle 200 may be of any geometric shape a long as the required insulating properties and proper positioning are attained.

In one possible embodiment, for example, the energy-saving baffle 100, 200 is manufactured to fit between engineered roof trusses 24 inches on center and manufactured to fit between conventional framed rafters 16 inches on center. Materials and installation may be the same for both applications.

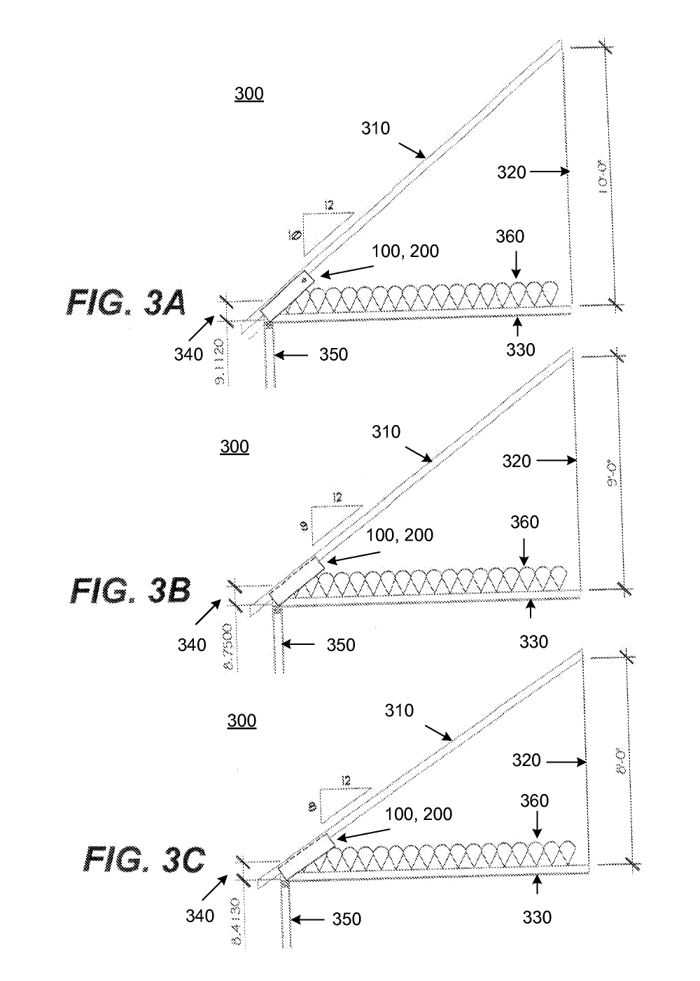

FIGS. 3A-3C show exemplary installation and positioning of the energy-saving baffle 100, 200 in the insulated area 300 in accordance with possible embodiments of the invention. As stated above, the insulating area 300 may be an attic, craw space, open ceiling, or any like area located above heated and/or cooled spaces needing insulation. The FIGS. 3A-3C diagrams illustrate the insulated area including the baffle 100, 200, the framing member (e.g., engineering truss, rafter, roofing beam, etc.) 310, the center of the framing member (truss or rafter structure) 320 which runs from the apex of the roof to the floor 330 of the insulated area 300, the measurement vertically 340 between the top plate of the exterior wall 350 and the contact point on the framing member 310, and fiberglass blown or batt insulation 360. While we use the term “framing member” throughout the application for ease of discussion, one of skill in the art would recognize that this term applies to any structure used in framing, such as an engineered truss, rafter, roofing beam, stud, etc., or a portion thereof. These terms will be used interchangeably throughout the application.

In this process, the framing contractor would be one of the likely individuals that would install the energy-saving baffle 100, 200. The framer would set the engineered roof trusses or rafter frame in an accustomed manner known to those of skill in the art. The framer would then proceed with the installation of fascia boards. Before sheathing the framer may need to install hurricane clips (such as Simpson Strong Tie CFS—H1) if required by building code. Finally, the framer will install the energy-saving baffle 100, 200 between the engineered roof trusses or framed rafters 310 and slide the energy-saving baffle 100, 200 down till it hits the top of the top plate of the exterior wall.

As discussed above, this process may require the installer (or framer, in the above example) to use pre-sized baffles 100, 200 which may be designed so that one size would meet all energy codes in use today. However, the baffles 100, 200 may be manufactured and sold in eight, ten, twelve, or 16 foot length pieces, for example, which may require the installer to calculate (e.g., using a computer program) and the proper length (or any other dimension, such as depth) of the energy-saving baffle 100, 200 and to cut the baffles 100, 200 to the calculated size to achieve the desire R-value for the required space.

As described in detail above, the energy-saving baffle 100, 200 may be fastened to a portion of the roofing structure such as the top cord of the truss or rafter 310 using any fastening device in any manner as discussed above.

With the flange attached to the energy-saving baffle 100, 200 in place and being fastened even with the top of truss or rafter top cord, the installer needs to make sure the energy-saving baffle 100, 200 is slid down to overlap the top plate of the exterior wall 350. If the installer slides the energy-saving baffle 100, 200 to far down towards the fascia, it will sit up higher than the truss or rafter and may cause the roof sheathing to buckle at that area and not sit on the truss or rafter 310. The flange may be manufactured to make improper installation the energy-saving baffle 100, 200 impossible.

When the energy-saving baffle 100, 200 is used in a home improvement project or retrofitting an existing condition, since the roof has been previously sheathed the installer may not be able to install the energy-saving baffle 100, 200 in the same manner as discussed above. For example, the installer would not be able to use fasteners, such as nails, screws, etc., with the flange. In this instance, the installer should be able to slide the energy-saving baffle 100, 200 from below and into place and secure with metal fasteners or using construction adhesive at the top end of the energy-saving baffle 100, 200.

If after installing the energy-saving baffle 100, 200, a portion of the baffle 100, 200 is found to be sitting below the bottom cord of the truss or rafter 310 (e.g., because the heel height is not large enough), the installer may have to use a handsaw or other bladed device to shave off a portion of the edge of the baffle 100, 200 that extend through. This process would result in a slight loss of R-value from the use of the whole baffle 100, 200, but should result in a much higher R-value than what is being replaced or required by code.

The energy-saving baffle 100, 200 may be designed to work well with a roof pitch of 4/12 or greater (i.e., a ratio of the height of the roof at the roof's apex as compared to the length from the apex at the base to the exterior wall). A steeper roof pitch will perform at a greater R-value. The R-value is measured vertically thereby giving more cavity insulation and R-value per rise in pitch. For example, when using an extruded polystyrene energy-saving baffle 100, 200, the industry standard is an R-value of R-5 per inch of material. When using an extruded polyurethane energy-saving baffle 100, 200, the industry standard is an R-value of R-5.6 per inch of material.

Therefore, in the examples shown in FIGS. 3A-3C, FIG. 3A shows an insulated area 300 under a 10/12 roof pitch. Assuming an extruded polyurethane energy-saving baffle 100, 200 is used and the raised heel height is 3.5 inches, yields a 9.112″ baffle 100, 200 measurement vertically at the contact point×5.6 R-value per inch=a total R-value of 51.02.

FIG. 3B shows an insulated area 300 under a 9/12 roof pitch. Assuming an extruded polyurethane energy-saving baffle 100, 200 is used and the raised heel height is 3.5 inches, yields a 8.75″ measurement vertically 340 at the contact point×5.6 R-value per inch=a total R-value of 49.00.

FIG. 3C shows an insulated area 300 under an 8/12 roof pitch. Assuming an extruded polyurethane energy-saving baffle 100, 200 is used and the raised heel height is 3.5 inches, yields a 8.413″ measurement vertically 340 at the contact point×5.6 R-value per inch=a total R-value of 47.11.

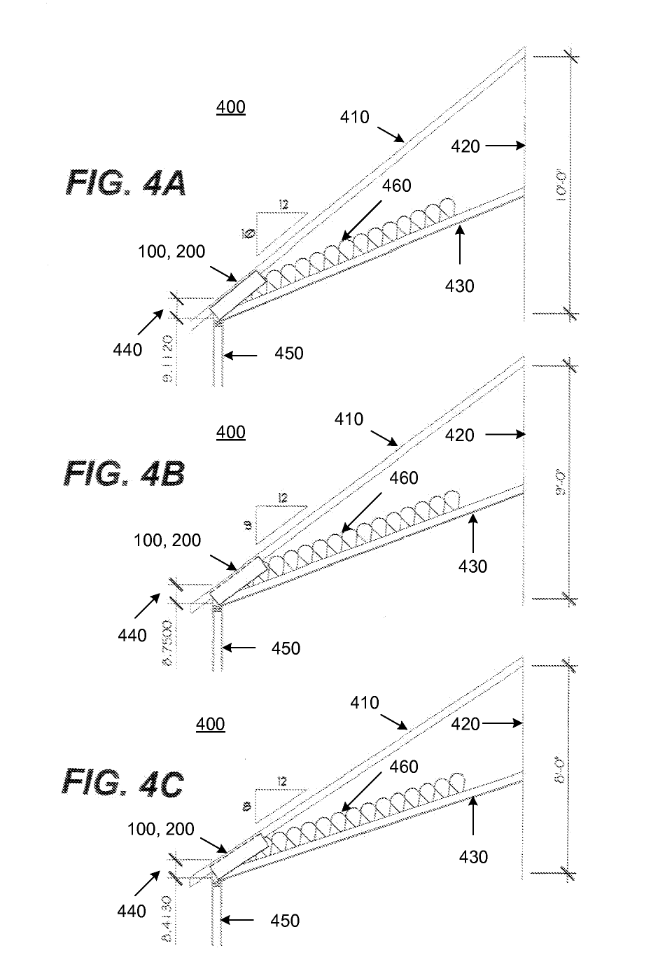

FIGS. 4A-4C shows exemplary installation and positioning of the energy-saving baffle 100, 200 in the insulated area 400 that uses a scissor beam 430 instead of the flat floor joists or beams 330 in accordance with possible embodiments of the invention. As stated above, the insulating area 400 may be an attic, craw space, open ceiling, or any like area located above heated and/or cooled spaces needing insulation. The FIGS. 4A-4C diagrams illustrate the insulated area including the baffle 100, 200, framing member (the engineering truss, rafter, roofing beam, etc.) 410, the center of the framing member structure 420 which runs from the apex of the roof of the insulated area 400 to a horizontal line running from the top plate of the exterior wall 450 to the center of the framing member structure, the measurement vertically 440 between the top plate of the exterior wall 450 and the contact point on the framing member 410, and fiberglass blown or batt insulation 460.

FIG. 4A shows an insulated area 400 under a 10/12 roof pitch. Assuming an extruded polyurethane energy-saving baffle 100, 200 is used, the raised heel height is 3.5 inches, a 5/12 scissor beam 430, and R-38 fiberglass batt insulation 460 is present, yields a 9.112″ baffle 100, 200 measurement vertically at the contact point×5.6 R-value per inch=a total R-value of 51.02.

FIG. 4B shows an insulated area 400 under a 9/12 roof pitch. Assuming an extruded polyurethane energy-saving baffle 100, 200 is used and the raised heel height is 3.5 inches, a 4.5/12 scissor beam 430, and R-38 fiberglass batt insulation 460 is present, yields a 8.75″ measurement vertically 440 at the contact point×5.6 R-value per inch=a total R-value of 49.00.

FIG. 4C shows an insulated area 400 under an 8/12 roof pitch. Assuming an extruded polyurethane energy-saving baffle 100, 200 is used and the raised heel height is 3.5 inches, a 4/12 scissor beam 430, and R-38 fiberglass batt insulation 460 is present, yields a 8.413″ measurement vertically 440 at the contact point×5.6 R-value per inch=a total R-value of 47.11.

In all of the above examples, the use of the energy-saving baffle 100, 200 increased the required R-value beyond the building code requirements.

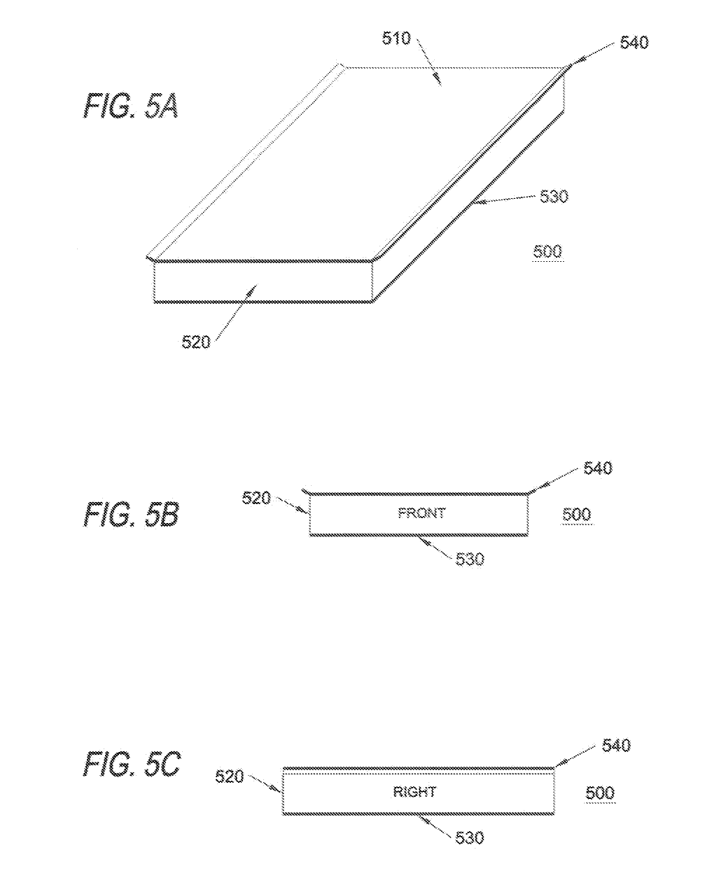

FIG. 5A illustrates another exemplary energy-saving baffle 500 in accordance with a possible embodiment of the invention. FIG. 5B shows a front view and FIG. 5C shows a side view of the exemplary energy-saving baffle 500. The energy-saving baffle 500 may be constructed of a core 520 made or a material such as polyurethane foam, polystyrene foam, or polyiso foam that is positioned between a top laminated radiant reflector 510 or any similar material, and a bottom laminated radiant reflector 530 or any similar material, for example, specifically manufactured to provide the desired insulating values. The core 520 is generally rigid which adds stability and ease of use by an installer. The top laminated radiant reflector 510 and the bottom laminated radiant reflector 530 may be made of any reflective flexible material, for example, such as a foil-type material having reflective and insulating values. However, one of skill in the art can appreciate that any insulating material may be used in accordance with the invention as long as the material provides the required insulating properties known to one of skill in the art.

With respect to possible embodiments for example, the energy-saving baffle 500 may be manufactured to fit between engineered roof trusses 24 inches on center or may be manufactured to fit between conventional framed rafters 16 inches on center. Materials and installation may be the same for both applications.

With FIG. 5A-5C shows the baffle 500 to be of rectangular shape, the baffle may be in the shape of a half-cylinder, half-sphere, rectangle, square, half-square, or any other polygon or three-dimensional shape as long as the required insulating properties are achieved.

The size of the baffle 500 may also vary. For example, the length of the baffle 500 can vary such that it may be pre-cut to provide a certain R-value, or it may be sold at a standard length. In this regard, the baffle 500 may be sold in eight, ten, or twelve foot lengths and may be cut to a desired length out in the field. A contractor can compute a proper length for the baffle 500 to meet and exceed the R-value threshold based on a table or through the use of a computer program.

The baffle 500 is shown in FIGS. 5A-5C to have flanges 540 on the lengthwise edges of the top laminated radiant reflector 510 to facilitate fitting between a framing member (rafter, roofing beam, etc.). The flanges 540 are attachable to the framing members and may create an area between the roof and the energy saving baffle 500 to allow a path for ventilation of the insulated space. However, the face of the baffle 500 facing the roofing beam can be smooth, have several ridges, etc. as long as the required insulating properties can be achieved.

The baffle 500 may be attached directly to the roofing beam but may also include an attachment device 110 connected to the baffle 500 to facilitate positioning the baffle atop the roofing beams. The attachment device 110 may be any type of attachment device known to those of skill in the art to allow the baffle 500 to fit atop roofing beam. For example, the attachment device 110 for the baffle 500 may include a flange or pair of flanges made of plastic or metal. The flanges may be attached to any structure as long as the desired insulating properties are achieved, including the roof, the roof sheathing, a framing member, a roofing beam or a rafter using any type of fastening devices. The fastening devices may be any type known to those of skill in the art including nails, tacks, staples, screws, rivets, glue, Velcro, tape, or clips. In addition, the flange may be designed to fit or slide inside of a rail or clip system designed to hold the flanges.

In one possible embodiment, for example, the energy-saving baffle 500 is manufactured to fit between engineered roof trusses 24 inches on center and manufactured to fit between conventional framed rafters 16 inches on center. Materials and installation may be the same for both applications.

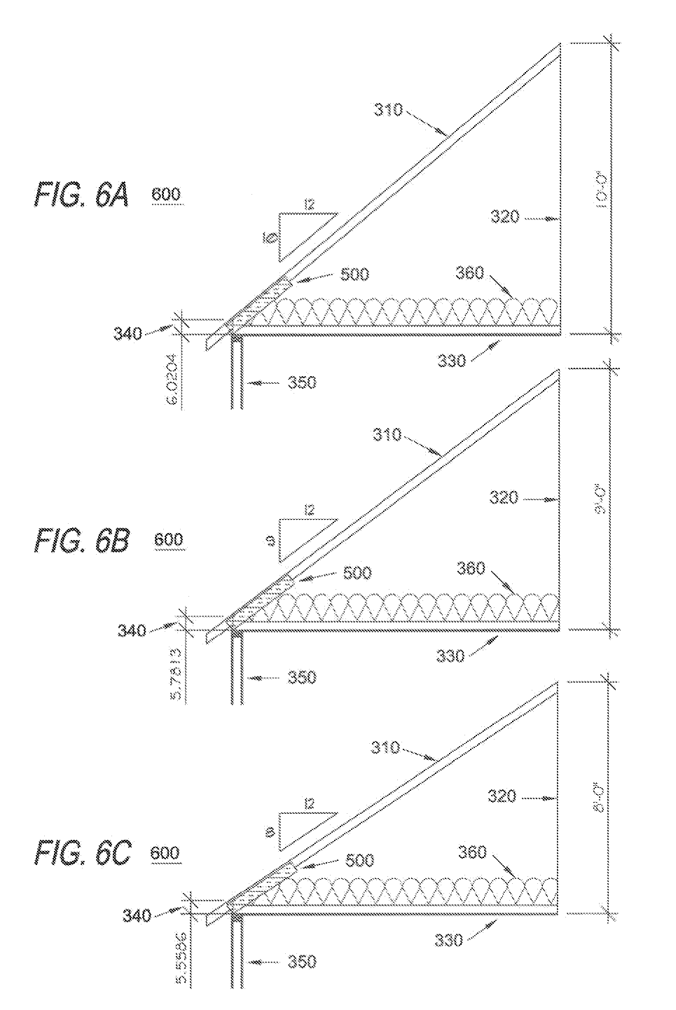

FIGS. 6A-6C show exemplary installation and positioning of the energy-saving baffle 500 in the insulated area 600 in accordance with possible embodiments of the invention. As stated above, the insulating area 600 may be an attic, craw space, open ceiling, or any like area located above heated and/or cooled spaces needing insulation. The FIGS. 6A-6C diagrams illustrate the insulated area including the baffle 500, the framing member (e.g., engineering truss, rafter, roofing beam, etc.) 310, the center of the framing member (truss or rafter structure) 320 which runs from the apex of the roof to the floor 330 of the insulated area 600, the measurement vertically 340 between the top plate of the exterior wall 350 and the contact point on the framing member 310, and fiberglass blown or batt insulation 360. While we use the term “framing member” throughout the application for ease of discussion, one of skill in the art would recognize that this term applies to any structure used in framing, such as an engineered truss, rafter, roofing beam, stud, etc., or a portion thereof. These terms will be used interchangeably throughout the application.

In this process, the framing contractor would be one of the likely individuals that would install the energy-saving baffle 500. The framer would set the engineered roof trusses or rafter frame in an accustomed manner known to those of skill in the art. The framer would then proceed with the installation of fascia boards. Before sheathing the framer may need to install hurricane clips (such as Simpson Strong Tie CFS—H1) if required by building code. Finally, the framer will install the energy-saving baffle 500 between the engineered roof trusses or framed rafters 310 and slide the energy-saving baffle 500 down till it hits the top of the top plate of the exterior wall.

As discussed above, this process may require the installer (or framer, in the above example) to use pre-sized baffles 500 which may be designed so that one size would meet all energy codes in use today. However, the baffles 500 may be manufactured and sold in eight, ten, twelve, or 16 foot length pieces, for example, which may require the installer to calculate (e.g., using a computer program) and the proper length (or any other dimension, such as depth) of the energy-saving baffle 500 and to cut the baffles 500 to the calculated size to achieve the desire R-value for the required space.

As described in detail above, the energy-saving baffle 500 may be fastened to a portion of the roofing structure such as the top cord of the truss or rafter 310 using any fastening device in any manner as discussed above.

With the flange attached to the energy-saving baffle 500 in place and being fastened even with the top of truss or rafter top cord, the installer needs to make sure the energy-saving baffle 500 is slid down to overlap the top plate of the exterior wall 350. If the installer slides the energy-saving baffle 500 to far down towards the fascia, it will sit up higher than the truss or rafter and may cause the roof sheathing to buckle at that area and not sit on the truss or rafter 310. The flange 540 may be manufactured to make improper installation the energy-saving baffle 500 impossible.

When the energy-saving baffle 500 is used in a home improvement project or retrofitting an existing condition, since the roof has been previously sheathed the installer may not be able to install the energy-saving baffle 500 in the same manner as discussed above. For example, the installer would not be able to use fasteners, such as nails, screws, etc., with the flange. In this instance, the installer should be able to slide the energy-saving baffle 500 from below and into place and secure with metal fasteners or using construction adhesive at the top end of the energy-saving baffle 500.

If after installing the energy-saving baffle 500, a portion of the baffle 500 is found to be sitting below the bottom cord of the truss or rafter 310 (e.g., because the heel height is not large enough), the installer may have to use a handsaw or other bladed device to shave off a portion of the edge of the baffle 500 that extend through. This process would result in a slight loss of R-value from the use of the whole baffle 500, but should result in a much higher R-value than what is being replaced or required by code.

The energy-saving baffle 500 may be designed to work well with a roof pitch of 4/12 or greater (i.e., a ratio of the height of the roof at the roof's apex as compared to the length from the apex at the base to the exterior wall). A steeper roof pitch will perform at a greater R-value. The R-value is measured vertically thereby giving more cavity insulation and R-value per rise in pitch. For example, when using an extruded polystyrene energy-saving baffle 500, the industry standard is an R-value of R-5 per inch of material. When using an energy-saving baffle 500 with a polyiso foam core and top and bottom laminated radiant reflectors 510, 530, the industry standard is an R-value of R-6.05 per inch of material.

Therefore, in the examples shown in FIGS. 6A-6C, FIG. 3A shows an insulated area 600 under a 10/12 roof pitch. Assuming an energy-saving baffle 500 with a polyiso foam core 520 with top and bottom laminated radiant reflectors 510, 530 is used and the raised heel height is 2 inches, this arrangement yields a 6.024″ baffle 500 measurement vertically at the contact point×6.56 R-value per inch=a total R-value of 39.5.

FIG. 6B shows an insulated area 600 under a 9/12 roof pitch. Assuming an energy-saving baffle 500 with a polyiso foam core 520 and top and bottom laminated radiant reflectors 510, 530 is used and the raised heel height is 2 inches, yields a 5.78″ measurement vertically 340 at the contact point×6.62 R-value per inch=a total R-value of 38.75.

FIG. 6C shows an insulated area 600 under an 8/12 roof pitch. Assuming an energy-saving baffle 500 with a polyiso foam core 520 and top and bottom laminated radiant reflectors 510, 530 is used and the raised heel height is 2 inches, yields a 5.55″ measurement vertically 340 at the contact point×6.68 R-value per inch=a total R-value of 37.08.

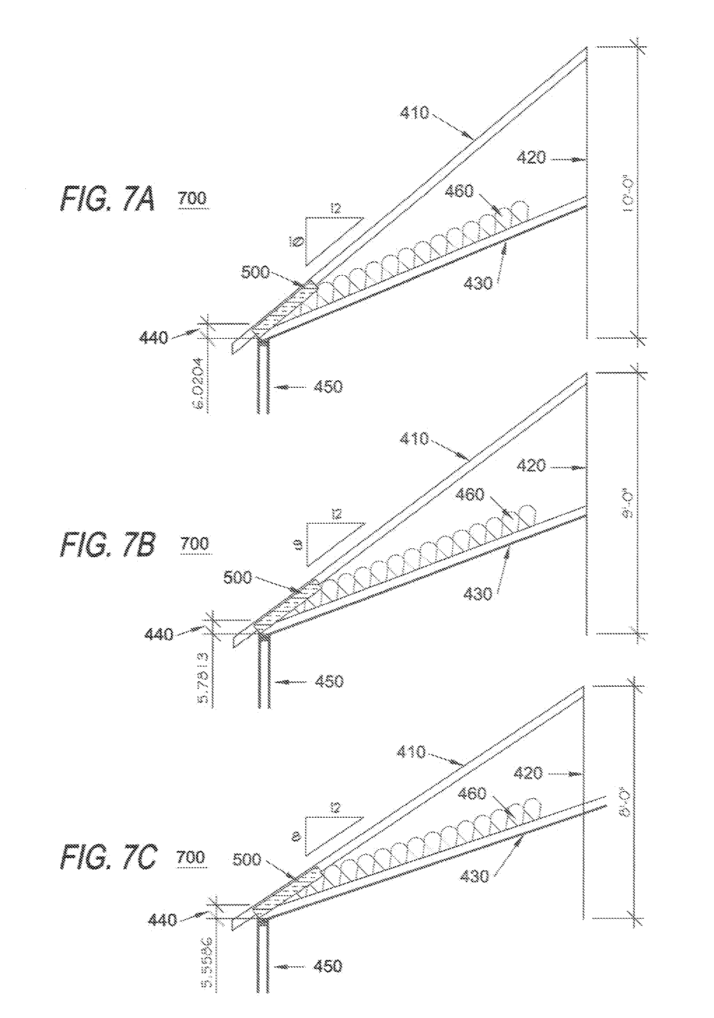

FIGS. 7A-7C shows exemplary installation and positioning of the energy-saving baffle 500 in the insulated area 700 that uses a scissor beam 430 instead of the flat floor joists or beams 330 in accordance with possible embodiments of the invention. As stated above, the insulating area 700 may be an attic, craw space, open ceiling, or any like area located above heated and/or cooled spaces needing insulation. The FIGS. 7A-7C diagrams illustrate the insulated area including the baffle 500, framing member (the engineering truss, rafter, roofing beam, etc.) 410, the center of the framing member structure 420 which runs from the apex of the roof of the insulated area 700 to a horizontal line running from the top plate of the exterior wall 450 to the center of the framing member structure, the measurement vertically 440 between the top plate of the exterior wall 450 and the contact point on the framing member 410, and fiberglass blown or batt insulation 460.

FIG. 7A shows an insulated area 700 under a 10/12 roof pitch. Assuming an energy-saving baffle 500 with a polyiso foam core 520 and top and bottom laminated radiant reflectors 510, 530 is used, the raised heel height is 2 inches, a 5/12 scissor beam 430, and R-38 fiberglass batt insulation 460 is present, yields a 6.024″ baffle 500 measurement vertically at the contact point×6.56 R-value per inch=a total R-value of 39.5.

FIG. 7B shows an insulated area 700 under a 9/12 roof pitch. Assuming an energy-saving baffle 500 with a polyiso foam core 520 and top and bottom laminated radiant reflectors 510, 530 is used and the raised heel height is 2 inches, a 4.5/12 scissor beam 430, and R-38 fiberglass batt insulation 460 is present, yields a 5.78″ measurement vertically 440 at the contact point×6.62 R-value per inch=a total R-value of 38.25.

FIG. 7C shows an insulated area 700 under an 8/12 roof pitch. Assuming an energy-saving baffle 500 with a polyiso foam core 520 and top and bottom laminated radiant reflectors 510, 530 is used and the raised heel height is 2 inches, a 4/12 scissor beam 430, and R-38 fiberglass batt insulation 460 is present, yields a 5.55″ measurement vertically 440 at the contact point×6.68 R-value per inch=a total R-value of 37.08.

In all of the above examples, the use of the energy-saving baffle 500 increased the required R-value beyond the building code requirements.

Although not required, the description above states that the proper factory, retail or in-the-field calculation of the proper R-value for a given application may be described, at least in part, in the general context of computer-executable instructions, being executed on a general-use computer or other processing device, for example. Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routine programs, objects, components, data structures, etc. that perform particular tasks or implement particular abstract data types. These instructions may performed on many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

Embodiments within the scope of the present invention may also include computer-readable media for carrying or having computer-executable instructions or data structures stored thereon concerning the calculation of the required size of the energy-saving baffle 500. Such computer-readable media can be any available media that can be accessed by a general purpose or special purpose computer, or server, for example. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Although the above description may contain specific details, they should not be construed as limiting the claims in any way. Other configurations of the described embodiments of the invention are part of the scope of this invention. Accordingly, the appended claims and their legal equivalents should only define the invention, rather than any specific examples given.

We claim:

1. An apparatus, comprising:
a baffle of synthetic material having insulating properties, and a shape and a size to be positioned beneath the roof and attached to framing members that connect a top plate of a wall with an apex of a roof, the baffle being positioned in proximity of the top plate, wherein the insulating properties and positioning of the synthetic baffle provide an increase of insulation R-value at or above a predetermined threshold in the area beneath the roof, wherein the baffle is rectangular in shape and has a uniform cross-section in the lengthwise direction, the baffle having ridges on at least two edges running lengthwise with the ridges and an area of the baffle between the ridges creating a path for ventilation,
wherein the baffle is made substantially of one of polyurethane and polystyrene and the predetermined threshold is at or above R-38.

2. The apparatus of claim 1, wherein the baffle is in the shape of one of a half-cylinder and a square.

3. The apparatus of claim 1, further comprising:
an attachment device that connects to the baffle to facilitate attaching the baffle to the framing members, the attachment device including one or more flanges made of one of plastic or metal.

4. The apparatus of claim 1, wherein the one or more flanges are attached to one of the roof, roof sheathing, the framing member, roofing beam and rafter using fastening devices, the fastening devices being one of nails, tacks, staples, screws, glue, Velcro, tape, and clips.

5. The apparatus of claim 1, wherein the framing members are one of a portion of a truss structure, roofing beam, roofing stud, and a rafter and the baffle is positioned between the framing members and a scissor beam and has a size and shape to attach to one or more framing members.

6. The apparatus of claim 1, wherein the baffle is positioned to allow ventilation for a soffit.

7. The apparatus of claim 1, wherein the synthetic material is manufactured in a manner that the baffle is cut to the required size from a larger size portion of the synthetic material.

8. A computer-readable medium storing instructions for controlling a computing device to compute the size of the baffle in claim 1 so that insulating value of the area in which the baffle is installed will meet or exceed a predetermined threshold.

9. A method of manufacturing, comprising:
forming a baffle of synthetic material having insulating properties and a shape and a size to be positioned beneath the roof and be attached to framing members that connect a top plate of a wall with an apex of a roof, the synthetic material being positioned in proximity of the top plate, wherein the insulating properties and positioning of the synthetic baffle provide an increase of insulation R-value at or above a predetermined threshold in the area beneath the roof,
wherein the baffle is rectangular in shape and has a uniform cross-section in the lengthwise direction, the baffle having ridges on at least two edges running lengthwise with the ridges and an area of the baffle between the ridges creating a path for ventilation, and
wherein the baffle is made substantially of one of polyurethane and polystyrene and the predetermined threshold is at or above R-38

10. An apparatus, comprising:
a baffle of synthetic material having insulating properties, and a shape and a size to be positioned beneath the roof and attached to framing members that connect a top plate of a wall with an apex of a roof, the baffle being positioned in proximity of the top plate, wherein the insulating properties and positioning of the synthetic baffle provide an increase of insulation R-value at or above a predetermined threshold in the area beneath the roof, wherein the baffle is rectangular in shape and has a uniform cross-section in the lengthwise direction,
the baffle comprising:
a core made substantially of one of polyurethane, polystyrene, and polyiso foam;
a bottom laminated radiant reflector coupled to the bottom of the core;
a top laminated radiant reflector coupled to the top of the core, and the a top laminated radiant reflector having a flange on at least two edges running lengthwise with the baffle, the flanges being attachable to the framing members and an area created by the attachment of the flanges to the framing members creating a path for ventilation,
wherein the predetermined threshold is at or above R-38,

11. The apparatus of claim 1, wherein the baffle is in the shape of one of a half-cylinder and a square.

12. The apparatus of claim 10, further comprising:
an attachment device that connects to the baffle to facilitate attaching the baffle to the framing members, the attachment device including one or more flanges made of one of plastic or metal.

13. The apparatus of claim 10, wherein the one or more flanges are attached to one of the roof, roof sheathing, the framing member, roofing beam and rafter using fastening devices, the fastening devices being one of nails, tacks, staples, screws, glue, Velcro, tape, and clips.

14. The apparatus of claim 10, wherein the framing members are one of a portion of a truss structure, roofing beam, roofing stud, and a rafter and the baffle is positioned between the framing members and a scissor beam and has a size and shape to attach to one or more framing members.

15. The apparatus of claim 10, wherein the baffle is positioned to allow ventilation for a soffit.

16. The apparatus of claim 10, wherein the synthetic material is manufactured in a manner that the baffle is cut to the required size from a larger size portion of the synthetic material.

17. A computer-readable medium storing instructions for controlling a computing device to compute the size of the baffle in claim 1 so that insulating value of the area in which the baffle is installed will meet or exceed a predetermined threshold.
